(19) United States
(12) Patent Application Publication
(10) Pub. No.: US 2023/0064726 A1
(43) Pub. Date: Mar. 2, 2023

(54) METHOD OF AGITATING LIQUID MANURE IN A LAGOON

(71) Applicant: Nuhn Industries Ltd., Sebringville (CA)

(72) Inventor: Ian NUHN, Stratford (CA)

(73) Assignee: Nuhn Industries Ltd., Sebringville, ON (CA)

(21) Appl. No.: 17/890,966

(22) Filed: Aug. 18, 2022

Related U.S. Application Data
(60) Provisional application No. 63/239,453, filed on Sep. 1, 2021.

(51) Int. Cl. A01C 3/02

(52) U.S. Cl. CPC A01C 3/026

(57) ABSTRACT

A method of agitating liquid manure in a lagoon involves: identifying a boundary perimeter in a lagoon within which an amphibious vehicle must remain while a liquid manure agitation device mounted on the vehicle agitates liquid manure in the lagoon; selecting an agitation pattern to be applied to the lagoon from a group of at least two agitation patterns; and, operating the amphibious vehicle to travel in the lagoon within the boundary perimeter while the liquid manure agitation device agitates the liquid manure in accordance with the selected agitation pattern. The group of at least two agitation patterns includes: a random pattern whereby the vehicle randomly changes direction of travel when the vehicle reaches the boundary perimeter; or, a sweep pattern whereby the vehicle is driven toward a liquid manure pump immersed in the lagoon to push suspended solids in the liquid manure toward the liquid manure pump.

### CROSS-REFERENCE TO RELATED APPLICATIONS

This application claims the benefit of United States Provisional Patent Application U.S. Ser. No. 63/239,453 filed Sep. 1, 2021, the entire contents of which is herein incorporated by reference.

### FIELD

This application relates to agriculture, in particular to a method of agitating liquid manure in a liquid manure storage lagoon.

### BACKGROUND

Liquid manure comprises a suspension of solid manure in a liquid medium (i.e., water). Liquid manure is often stored in a large lagoon for use later for fertilizing fields. When use of the stored liquid manure is desired, a pump immersed in the liquid manure lagoon is used to pump the liquid manure out of the lagoon into a tank of a liquid manure spreader. However, liquid manure has a high concentration of solid material, which, over time, settles out to collect as sediment on the bottom of the lagoon. To ensure that the solids are more or less homogeneously suspended in the liquid, especially just prior to and during pumping of the liquid manure out of the lagoon, an agitator device is used to agitate the liquid manure thereby keeping the solids mixed in the liquid. Due to the size of the lagoon, the agitator device is often mounted on a mobile amphibious vehicle that can travel throughout the lagoon mixing the liquid manure as the vehicle travels. An example of an amphibious vehicle is disclosed in U.S. Pat. No. 9,694,636 issued Jul. 4, 2017, the entire contents of which is herein incorporated by reference.

At different times there are different needs with respect to agitation and movement of the liquid manure in the lagoon. It would be desirable to have a method of agitating liquid manure in a liquid manure lagoon that can accommodate the different needs at the different times.

### SUMMARY

A method of agitating liquid manure in a liquid manure lagoon, the method comprising: identifying a boundary perimeter in a liquid manure lagoon within which an amphibious vehicle must remain while a liquid manure agitation device mounted on the vehicle agitates liquid manure in the lagoon; selecting an agitation pattern to be applied to the lagoon from a group of at least two agitation patterns; and, operating the amphibious vehicle to travel in the lagoon within the boundary perimeter while the liquid manure agitation device agitates the liquid manure in the lagoon in accordance with the selected agitation pattern.

A non-transient computer-readable storage medium has instructions embodied thereon, the instructions being executable by one or more processors to perform the method described above.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 is a flow chart illustrating a method of agitating liquid manure in a liquid manure lagoon.

FIG. 2 depicts a random pattern for an amphibious vehicle operating in a liquid manure lagoon while a liquid manure agitation device mounted on the vehicle agitates liquid manure in the lagoon.

FIG. 3 depicts a sweep pattern for an amphibious vehicle operating in a liquid manure lagoon whereby the vehicle is driven toward a liquid manure pump immersed in the lagoon to push suspended solids in the liquid manure toward the liquid manure pump.

FIG. 4 depicts a switch pattern that comprises both the random pattern and the sweep pattern.

FIG. 5 depicts a schematic diagram of a control system for controlling an amphibious vehicle in a liquid manure lagoon to agitate liquid manure in the lagoon.

### DETAILED DESCRIPTION

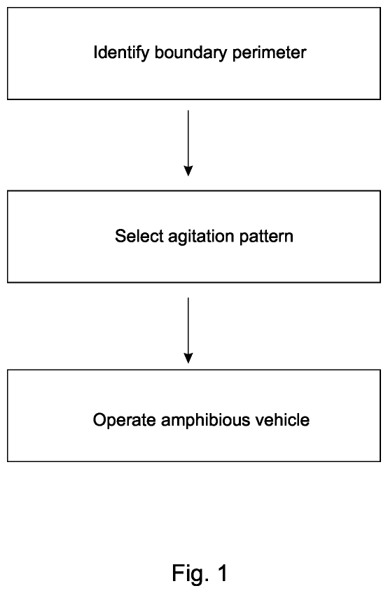

FIG. 1 illustrates a method of agitating liquid manure in a liquid manure lagoon. First, a boundary perimeter is identified in a liquid manure lagoon within which an amphibious vehicle must remain while a liquid manure agitation device mounted on the vehicle agitates liquid manure in the lagoon. In order to identify the boundary perimeter, the amphibious vehicle preferably comprises a space-based global navigation satellite system (GNUS) receiver, for example a global positioning system (GPS) receiver. The boundary perimeter is identified by operating the amphibious vehicle to travel inside of and around a physical perimeter wall of the lagoon while the GNSS receiver collects boundary position data and saves the boundary position data in the computer memory. The boundary perimeter is thereby delineated as a virtual fence from the boundary position data saved in the computer memory. The boundary position data represents ‘fenceposts’ that mark the virtual fence. All or part of the virtual fence, which is representative of the boundary perimeter, may be co-located in space with the physical perimeter wall of the lagoon. In some embodiments, the boundary perimeter is located within the lagoon with a gap between the physical perimeter wall and the boundary perimeter. Once the boundary perimeter is identified, an agitation pattern to be applied to the lagoon is selected from a group of at least two agitation patterns. Once the agitation pattern is selected, the amphibious vehicle is operated to travel in the lagoon within the boundary perimeter while the liquid manure agitation device agitates the liquid manure in the lagoon in accordance with the selected agitation pattern.

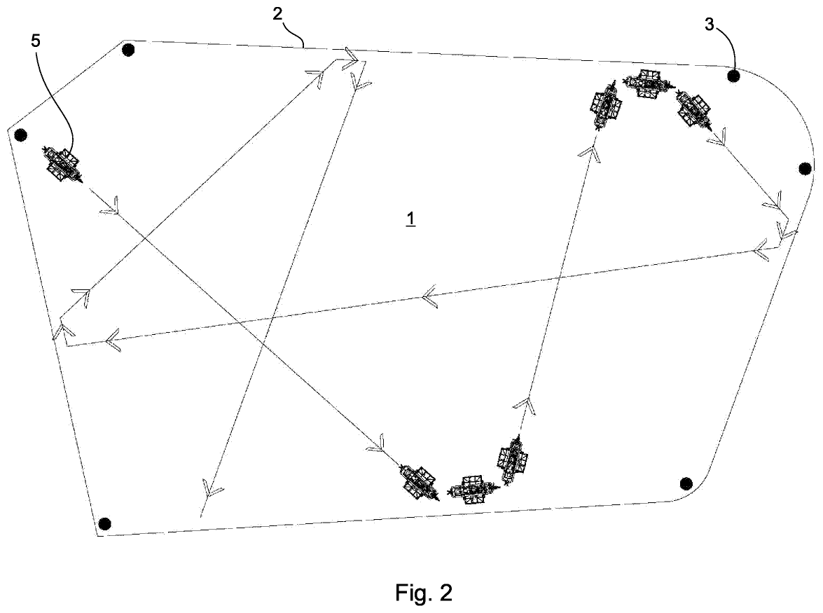

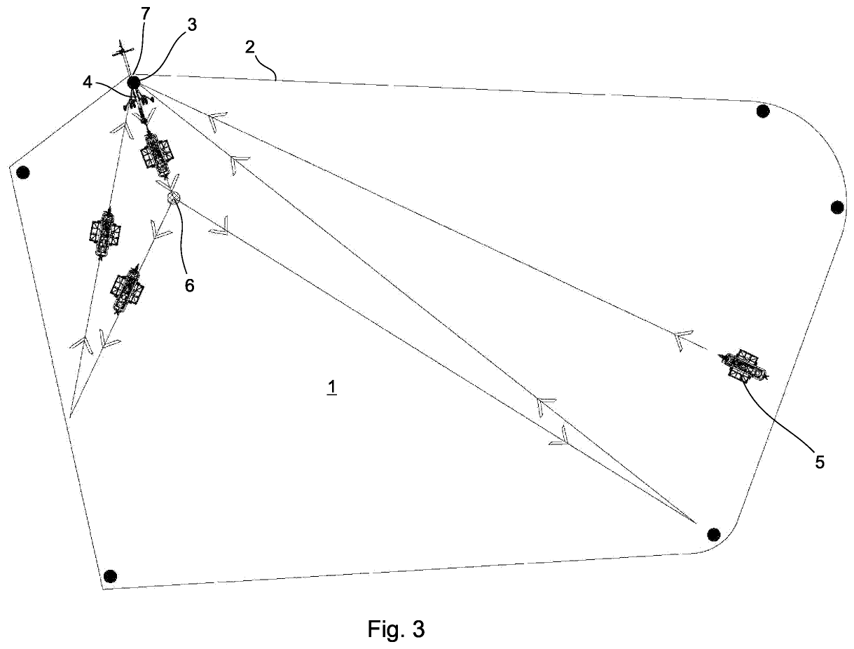

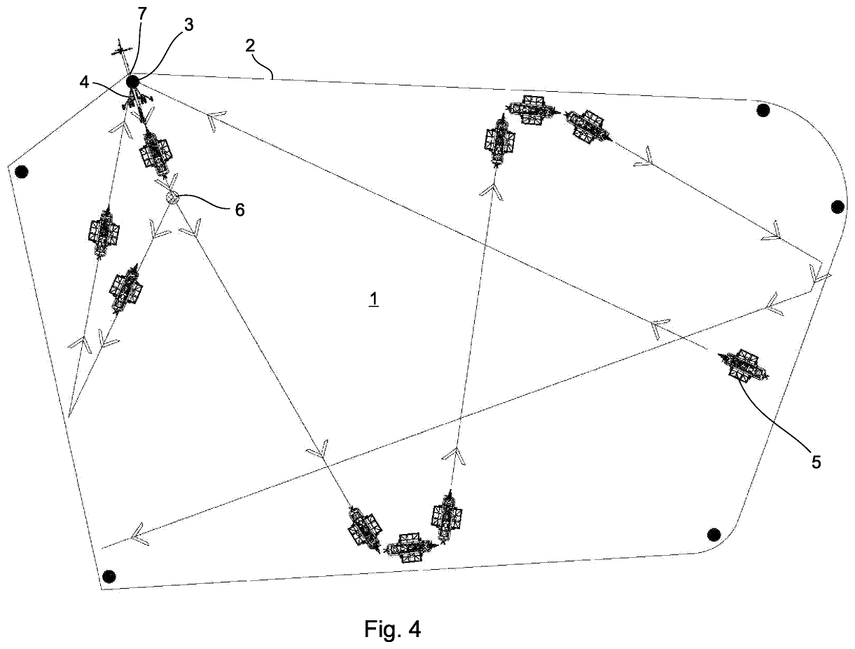

In some embodiments, the group of at least two agitation patterns comprises both a random pattern, illustrated in FIG. 2, and a sweep pattern, illustrated in FIG. 3. The group of at least two agitation patterns may further comprise a switch pattern, illustrated in FIG. 4, whereby the vehicle is driven in an alternating cycle between the random pattern and the sweep pattern. In some embodiments, the group of at least two agitation patterns may consist of three agitation patterns. In some embodiments, the three agitation patterns are the random pattern, the sweep pattern and the switch pattern. In some embodiments, the method may comprise other agitation patterns instead of or in addition to the random, sweep and/or switch patterns.

In the random pattern (FIG. 2), an amphibious vehicle 5 having a liquid manure agitation device mounted thereon is driven in a liquid manure lagoon 1 at a selected speed towards a boundary perimeter 2 delineated from fenceposts 3 (only one labeled) identified previously. The amphibious vehicle 5 drives in straight lines (arrowed lines in FIG. 2) until the amphibious vehicle 5 reaches the boundary perimeter 2, at which time a reflection angle is randomly generated and the amphibious vehicle 5 is turned to drive in a new direction commensurate with the randomly generated reflection angle. The process of driving the amphibious vehicle 5 to the boundary perimeter 2, randomly generating a reflection angle and turning the amphibious vehicle 5 to drive in a new direction is repeated over and over. The random pattern is similar in appearance to old screen savers on computer monitors, and is most useful for driving the amphibious vehicle 5 over the entire lagoon in order to agitate sediments off a bottom of the lagoon.

In the sweep pattern (FIG. 3), the amphibious vehicle 5 is operated to drive in straight lines (arrowed lines in FIG. 3) toward a liquid manure pump 4 immersed in the lagoon 1 and located at one of the fenceposts 3 to push suspended solids in the liquid manure toward the liquid manure pump 4 so that the liquid manure pump 4 can pump manure-rich liquid manure out of the lagoon 1. An operator can specify which fencepost 3 to which the amphibious vehicle 5 is driven based on the desired location of the liquid manure pump 4. In the sweep pattern, a front of the amphibious vehicle 5 is always faced towards the liquid manure pump 4. Once the amphibious vehicle 5 reaches the liquid manure pump 4, the amphibious vehicle 5 is operated to back away from the liquid manure pump 4 at a fixed angle that is half an angle of a corner 7 of the boundary perimeter 2 for a predetermined distance to a turn point 6. At the turn point 6, the amphibious vehicle 5 is turned at a randomly generated angle and operated to continue backing up until the amphibious vehicle 5 reaches the boundary perimeter 2. Once the amphibious vehicle 5 reaches the boundary perimeter 2, the amphibious vehicle 5 is operated to change direction to drive again towards the liquid manure pump 4 pushing manure towards the liquid manure pump 4. Once, the amphibious vehicle 5 again reaches the liquid manure pump 4, the amphibious vehicle 5 is operated to repeat the cycle. The fencepost 3 at which the liquid manure pump 4 is located is preferably in a corner 7 that has an acute angle. By operating the amphibious vehicle 5 to back away from the liquid manure pump 4 in the corner 7 to reach the turn point 6 before turning the amphibious vehicle 5, a collision is avoided with the physical perimeter wall of the lagoon 1, which is usually very close to the boundary perimeter 2. The purpose of the sweep pattern is to push suspended solids towards the liquid manure pump 4 to increase the likelihood that the lagoon 1 will be cleaned out properly and consistently from start to finish. Further, concentration of manure in the liquid manure can vary considerably over the time required to pump out a lagoon, but the sweep pattern ensures a more consistent nutrient (manure) content throughout the duration of emptying the lagoon.

In the switch pattern (FIG. 4), the amphibious vehicle 5 is operated in an alternating cycle between the random pattern and the sweep pattern. An operator is able to choose the duration of each pattern and the speed that the amphibious vehicle 5 performs each pattern. For example, the random pattern can be operated for a longer period of time at a slow speed to ‘boil’ up solids from the bottom of the lagoon, and then switch to the sweep pattern where the amphibious vehicle 5 is operated for a shorter period of time at a faster speed to push newly suspended manure toward the liquid manure pump 4. The switch pattern has the amphibious vehicle 5 moving back and forth quickly pushing the newly suspended material towards the liquid manure pump 4. The amphibious vehicle 5 repeats the switch pattern cycle continuously or until the operator changes the pattern or stops the amphibious vehicle 5 entirely.

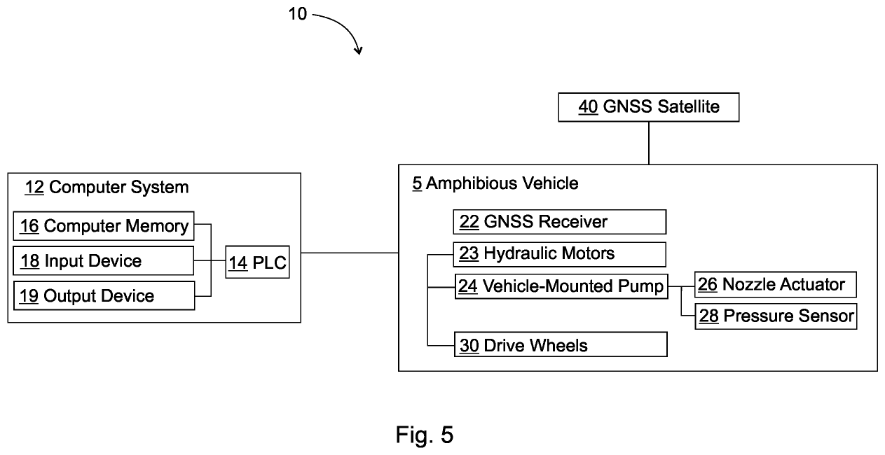

The method may be automated by programming a programmable logic controller (PLC) of a control system. FIG. 5 depicts a schematic diagram of a control system 10 for controlling the amphibious vehicle 5 in a liquid manure lagoon. In the control system 10. a PLC 14 is embodied in a computer system 12, which may be situated on the amphibious vehicle 5, or at a location remote from the amphibious vehicle 5, or some parts may be located on the amphibious vehicle 5 and other parts remotely from the amphibious vehicle 5. The PLC 14 is in electronic communication with an input device 18 and/or an output device 19 so that the PLC 14 can receive information from an operator and/or communicate information to the operator. The PLC 14 is in electronic communication with a non-transient computer memory 16, which is preferably a component of the computer system 12 in which the PLC 14 is embodied. The computer memory 16 comprises data files and instructions on which the PLC 14 acts. The input device 18 and/or the output device 19 can be located on the amphibious vehicle 5, but are preferably located remotely from the amphibious vehicle 5.

The amphibious vehicle 5 is in electronic communication with the computer system 12. The amphibious vehicle 5 is equipped with a GNSS receiver 22, which receives position data wirelessly from a GNSS satellite 40. If the input device 18 and/or the output device 19 are located remotely from the amphibious vehicle 5, the amphibious vehicle 5 may comprise a wireless receiver for receiving electronic signals from the input device 18 and a wireless transmitter for transmitting signals to the output device 19. Instructions for selecting the agitation pattern and operating the amphibious vehicle 5 to travel in the lagoon within the boundary perimeter are contained in the computer memory 16 for the PLC to act upon, the programmable logic controller performing the method in accordance with the instructions.

In some embodiments, speed of the amphibious vehicle 5 is also determined using the GNSS receiver 22. Operating position data is collected by the GNSS receiver 22 during operation of the amphibious vehicle 5. Operating position data comprises information about the location of the amphibious vehicle 5 in the lagoon while the amphibious vehicle 5 is traveling in the lagoon. Speed of the amphibious vehicle 5 may be determined from a time increment required for the amphibious vehicle 5 to travel in a straight line between two operating positions.

The instructions for operating the amphibious vehicle 5 preferably further comprise instructions for controlling the speed of the amphibious vehicle 5. Control of the speed may be done to correspond to a selected speed setting or may be controlled in a continuous manner. Preferably, the amphibious vehicle 5 has one or a plurality of set speeds at which the amphibious vehicle 5 is operated and speed control of the amphibious vehicle 5 is done to correspond to the one or plurality of selected speed settings. The selected speed settings preferably comprise an ‘off’ setting as well as one or more other speed settings. In a preferred embodiment, there are five preset selected speeds to choose from.

The instructions for controlling the speed of the amphibious vehicle 5 preferably account for environmental conditions in the lagoon. Environmental conditions in the lagoon may be related to resistance to movement of the amphibious vehicle 5 caused by obstacles (e.g., sediment piles), consistency of the liquid manure, wind conditions (e.g., strength and direction of the wind), and the like. In some embodiments, depending on the extent of resistance to movement of the amphibious vehicle 5 caused by the environmental conditions, motive power to the amphibious vehicle 5 can be increased or decreased to correspond to the selected speed setting.

The liquid manure agitation device preferably comprises a vehicle-mounted pump 24 in fluid communication with a movable outlet nozzle. The vehicle-mounted pump 24 is preferably configured to pump liquid manure out of the lagoon through the nozzle back into the lagoon to cause agitation of the liquid manure in the lagoon, and preferably also to propel the amphibious vehicle 5, although propulsion could be accomplished with a separate structure. The vehicle-mounted pump 24 is operated by a motive device, for example an engine, a motor, a generator or the like. A hydraulic motor is preferred, which may be one of a plurality of hydraulic motors 23 on the amphibious vehicle 5. The instructions for operating the amphibious vehicle 5 may further comprise instructions for operating the vehicle-mounted pump 24 and the movable outlet nozzle. In such embodiments, the speed of the amphibious vehicle 5 may be controlled based on a state of the nozzle, which serves as a proxy for the environmental conditions affecting the speed of the amphibious vehicle 5. For example, angle of the nozzle may be controlled by a nozzle actuator 26, and the state of the nozzle may comprise back-pressure on the actuator 26. The amount of back-pressure on the nozzle actuator 26 can be correlated to the speed of the amphibious vehicle 5 and the vehicle-mounted pump 24 can be controlled to provide more or less thrust depending on the back-pressure measured on the actuator 26. Thrust, and therefore speed, can be altered by changing the angle of the nozzle with respect to horizontal. Further, when the back-pressure on the actuator 26 at the end of the stroke of the actuator 26 is equal to a relief pressure setting for the actuator 26, the vehicle-mounted pump 24 may be switched off, saving much energy. Back-pressure may be measure using one or more pressure sensors 28. In some embodiments, the actuator 26 comprises a hydraulic cylinder. The hydraulic cylinder may be part of a hydraulic circuit in which hydraulic fluid is pressurized by the motive device, preferably one of the hydraulic motors 23. Switching off the actuator 26 when the back-pressure is equal to the relief pressure also prevents overheating of the hydraulic system when the actuator 26 is a hydraulic cylinder caused by constantly blowing oil over relief when the cylinder is at end of stroke.

Because speed of the amphibious vehicle 5 can be determined, it is possible to determine if the amphibious vehicle 5 becomes stuck, for example on a sediment pile in the lagoon. Therefore, in some embodiments, the amphibious vehicle 5 may further comprise a wheel drive 30 for driving the amphibious vehicle 5 on land. The wheel drive 30 is operated by a motive device, for example an engine, a motor, a generator or the like. Preferably, the wheel drive 30 is operated by the same type of motive device as the vehicle-mounted pump 24. Preferably, one or more of the hydraulic motors 23 is used to operate the wheel drive 30. The instructions for operating the amphibious vehicle 5 may further comprise instructions for operating the wheel drive 30. In some embodiments, when the amphibious vehicle 5 travels less than a predetermined distance within a predetermined period of time in the lagoon, the wheel drive 30 is operated to move the amphibious vehicle 5 in a forward direction. For example, the wheel drive 30 can be operated to cycle through an ‘on/off’ cycle for a period of time where each ‘on’ and ‘off’ period lasts for a certain duration (e.g., about 10 seconds). If the amphibious vehicle 5 travels less than a predetermined distance within a predetermined period of time in the lagoon after the wheel drive 30 is operated to move the amphibious vehicle 5 in the forward direction, then the amphibious vehicle 5 is operated to move in a reverse direction. Initially, the amphibious vehicle 5 can be instructed to use the movable nozzles to move the amphibious vehicle 5 in the reverse direction. However, if the amphibious vehicle 5 travels less than a predetermined distance within a predetermined period of time in the lagoon after the movable nozzles are operated to move the amphibious vehicle 5 in the reverse direction, then the amphibious vehicle 5 is instructed to cycle the wheel drive 30 through an ‘on/off’ cycle in the reverse direction. After becoming unstuck when operated in reverse as described above, the amphibious vehicle 5 continues in reverse until the amphibious vehicle 5 is reaches the boundary perimeter 2, at which time a new reflection angle is generated and the amphibious vehicle 5 continues in the selected agitation pattern.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A method of agitating liquid manure in a liquid manure lagoon, the method comprising:
identifying a boundary perimeter in a liquid manure lagoon within which an amphibious vehicle must remain while a liquid manure agitation device mounted on the vehicle agitates liquid manure in the lagoon;
selecting an agitation pattern to be applied to the lagoon from a group of at least two agitation patterns; and,
operating the amphibious vehicle to travel in the lagoon within the boundary perimeter while the liquid manure agitation device agitates the liquid manure in the lagoon in accordance with the selected agitation pattern.

2. The method of claim 1, wherein the group of at least two agitation patterns comprises:
a random pattern whereby the vehicle randomly changes direction of travel when the vehicle reaches the boundary perimeter; or,
a sweep pattern whereby the vehicle is driven toward a liquid manure pump immersed in the lagoon to push suspended solids in the liquid manure toward the liquid manure pump.

3. The method of claim 2, wherein the group of at least two agitation patterns comprises both the random pattern and the sweep pattern.

4. The method of claim 2, wherein the group of at least two agitation patterns further comprises a switch pattern whereby the vehicle is driven in an alternating cycle between the random pattern and the sweep pattern.

5. The method of claim 1, wherein the group of at least two agitation patterns consists of three agitation patterns.

6. The method of claim 1, wherein the liquid manure agitation device comprises a vehicle-mounted pump in fluid communication with a movable outlet nozzle, the vehicle-mounted pump configured to pump liquid manure out of the lagoon through the nozzle back into the lagoon to cause agitation of the liquid manure in the lagoon.

7. The method of claim 1, wherein instructions for selecting the agitation pattern and operating the amphibious vehicle to travel in the lagoon within the boundary perimeter are programmed into a programmable logic controller (PLC) in electronic communication with the amphibious vehicle, the programmable logic controller performing the method in accordance with the instructions.

8. The method of claim 1, wherein:
the amphibious vehicle comprises a space-based global navigation satellite system (GNSS) receiver,
the boundary perimeter is identified by operating the amphibious vehicle to travel inside of and around a physical perimeter wall of the lagoon while the GNSS receiver collects boundary position data and saves the boundary position data in a computer memory, and
the boundary perimeter is delineated as a virtual fence by the boundary position data saved in the computer memory.

9. The method of claim 8, wherein instructions for selecting the agitation pattern and operating the amphibious vehicle to travel in the lagoon within the boundary perimeter are programmed into a programmable logic controller (PLC) in electronic communication with the amphibious vehicle, the programmable logic controller performing the method in accordance with the instructions.

10. The method of claim 9, wherein speed of the amphibious vehicle is determined from operating position data collected by the GNSS receiver during operation of the amphibious vehicle.

11. The method of claim 10, wherein the instructions for operating the amphibious vehicle further comprise instructions for controlling the speed of the amphibious vehicle.

12. The method of claim 11, wherein the instructions for controlling speed of the amphibious vehicle account for environmental conditions in the lagoon.

13. The method of claim 11, wherein:
the liquid manure agitation device comprises a vehicle-mounted pump in fluid communication with a movable outlet nozzle, the vehicle-mounted pump configured to pump liquid manure out of the lagoon through the nozzle back into the lagoon to propel the amphibious vehicle and cause agitation of the liquid manure in the lagoon;
the instructions for operating the amphibious vehicle further comprise instructions for operating the vehicle-mounted pump and the movable outlet nozzle; and,
the speed of the amphibious vehicle is controlled based on a state of the nozzle.

14. The method of claim 13, wherein movement of the nozzle is controlled by an actuator, the state of the nozzle is back-pressure on the actuator and the vehicle-mounted pump is switched off when the back-pressure is equal to a relief pressure setting for the actuator.

15. The method of claim 14, wherein the actuator comprises a hydraulic cylinder.

16. The method of claim 9, wherein:
the amphibious vehicle further comprises a wheel drive for driving the amphibious vehicle on land;
the instructions for operating the amphibious vehicle further comprise instructions for operating the wheel drive; and,
when the amphibious vehicle travels less than a predetermined distance within a predetermined period of time in the lagoon, the wheel drive is operated to move the amphibious vehicle in a forward direction.

17. The method of claim 16, wherein the amphibious vehicle is operated to move in a reverse direction if the amphibious vehicle travels less than the predetermined distance within the predetermined period of time in the lagoon after the wheel drive is operated to move the amphibious vehicle in the forward direction.

18. A non-transient computer-readable storage medium having instructions embodied thereon, the instructions being executable by one or more processors to perform the method of claim 1.
